(19) United States
(12) Patent Application Publication
(10) Pub. No.: US 2016/0086137 A1
(43) Pub. Date: Mar. 24, 2016

(54) MOBILE DEVICE PROXIMITY-BASED MATCHMAKING

(71) Applicant: Ackerdating, LLC, New York, NY (US)

(72) Inventor: Ari J. Ackerman, New York, NY (US)

(21) Appl. No.: 14/597,075

(22) Filed: Jan. 14, 2015

Related U.S. Application Data
(60) Provisional application No. 62/052,330, filed on Sep. 18, 2014.

(51) Int. Cl. G06Q 10/10; G06Q 50/00; H04W 4/02

(52) U.S. Cl. CPC G06Q 10/1095; H04W 4/02; G06Q 50/01

(57) ABSTRACT

A mobile matchmaking system relies upon common characteristics to connect two people and then, if they choose to meet, will automatically present date options, and/or generate a date event, for them according to certain criteria.

### CROSS REFERENCE TO RELATED APPLICATION

This application claims the priority benefit of U.S. Provisional Patent Application No. 62/052,330, filed Sep. 18, 2014, which is incorporated herein by reference in its entirety as if fully set forth herein.

### BACKGROUND

1. Field

This disclosure relates generally to mobile computing, and, more particularly, to mobile computing applications.

2. Background

Online dating has become a prevalent way for people to connect and potentially form relationships. However, once two people have connected, if they intend to meet they must still rely upon the common, old fashioned approach for doing so.

### BRIEF SUMMARY

A mobile device proximity-based matchmaking system is disclosed herein that relies upon common characteristics to connect two people as a match and, depending upon the implementation, it will allow a user to select from among multiple automatically generated date options and allow a user to ask one of their matches out on a date with the selected date option. Or, with other implementations, the system will automatically present a user with one or more date options to select generate a date event for the user and their match accepted match according to certain criteria.

In one aspect of this disclosure, a mobile device proximity-based matchmaking system comprises a mobile device including a processor, and non-transient application software running on the processor of the mobile device. The application software is configured to, when executed, implement a matching engine. The application software is further configured to, when executed, cause the processor of the mobile device to: i) use information, supplied by the user of the proximity-based matchmaking system, in the matching engine to identify multiple potential matches for the user by comparing at least some of the information supplied by the user to information supplied by other registered users of the proximity-based matchmaking system; ii) identify to the user, in a graphical user interface (GUI) of the user's mobile device, potential matches from among the other registered users based upon at least the information supplied by other registered users; iii) receive an indication from the user via the GUI that the user has approved at least one of the potential matches; iv) send a notification to the at least one of the potential matches indicating the selection; v) receive from the at least one of the potential matches an approval of the user such that the at least one potential match will be a matched user; vi) receive an “AskOut” selection from the user via the GUI with respect to the matched user; vii) automatically generate, based upon information from the user and the matched user, at least one date event and present the at least one date event to the user via the GUI; viii) receive date-related input from the user via the GUI; ix) transmit at least one particular date event to the matched user; x) receive an indication from the matched user of their acceptance of a specific date event selected from among the at least one particular date event; and xi) automatically book a reservation for the specific date event.

The foregoing outlines rather generally features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 illustrates, in simplified functional form, a flowchart for an example implementation of the user sign-up process;

FIGS. 2A-2C illustrate, in simplified form, representative examples of graphical user interfaces (GUIs) that can be presented to a user on, for purposes of this example, a smart phone;

FIG. 3 illustrates, in simplified functional form, a flowchart for an example implementation of the matching process;

FIG. 4A illustrates, in simplified form, a representative example of a template for a GUI that might be presented to a user in connection with Steps 304 and 306 of FIG. 3;

FIG. 4B illustrates, in simplified form, the template of FIG. 4A as it might be populated (using a fictitious example) following a search for matches for a user;

FIG. 5 illustrates, in simplified form an example representation of a system as described herein in its environment; and

FIG. 6 illustrates, in simplified form, a flowchart for the “AskOut” process.

### DETAILED DESCRIPTION

In broad overview, described herein is a mobile matchmaking application that relies upon common characteristics to connect two people and then, if they choose to meet, will automatically generate a date event for them according to certain criteria.

Optionally, the matchmaking application is configured to interoperate with one or more social networking sites, such as (but not limited to) Facebook, LinkedIn, Google+, etc.

The mobile matchmaking application is preferably primarily based upon religious affiliation and level of observance or practice, but allows for specifying and/or selection of other criteria, such as (but not limited to) gender, age, ethnicity, distance, specific likes/dislikes, etc.

Although the matchmaking application is primarily for use on (and described in connection with) mobile devices (e.g., processor-containing, non-transient application software executing, smart phones, wearables (smart glasses, smart watches, in-vehicle displays, etc.), tablet computers, laptops, etc.), it should be understood that nothing herein prevents the aspects described herein from being presented on a non-mobile device, for example, a desktop computer.

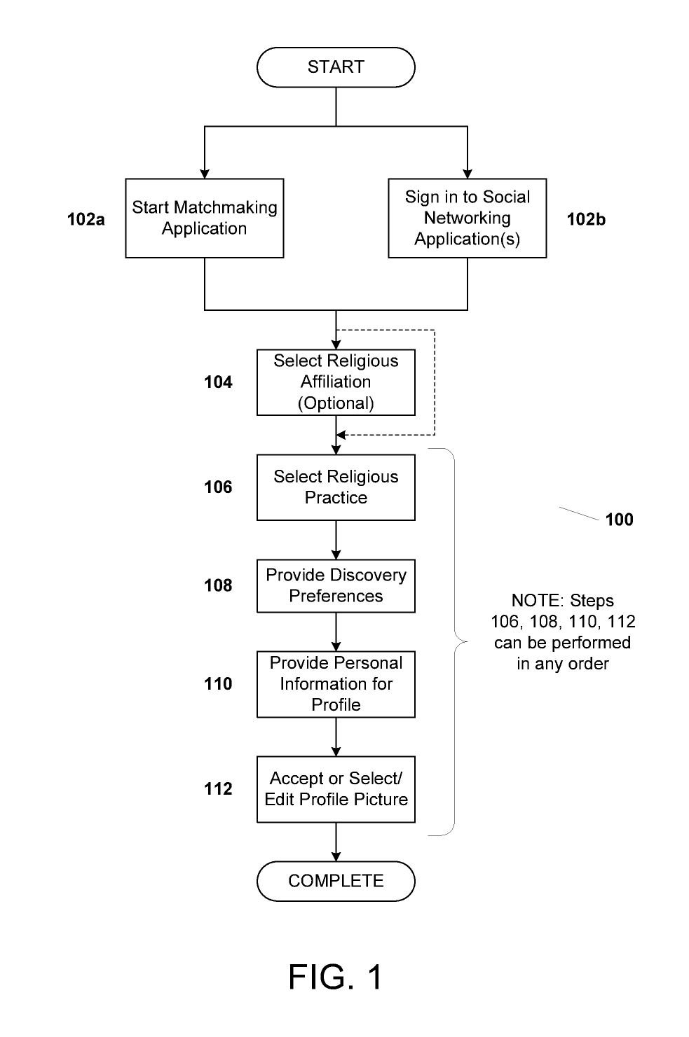

Users wishing to use the application start the application running and must initially set up an account (i.e., sign-up). FIG. 1 illustrates, in simplified functional form, a flowchart 100 for an example implementation of the user sign-up process. The process begins with the user both starting the matchmaking application (Step 102a) and signing in to one or more social networking application sites with which they are registered, such as (but not limited to) Facebook, LinkedIn, Google+, etc. (Step 102b) in any order. Next, the user is optionally prompted to select their religious affiliation (Step 104). Thereafter, upon receipt of input by the user, or directly if the application is religious affiliation-specific, the user is prompted to select her level or degree of religious practice (Step 106). In this manner, more observant people can be connected with those of similar observance levels. Upon receipt of that input, the user is next prompted to provide their “discovery preferences” (Step 108). As will be explained in greater detail below, discovery preferences allow users to affect how discoverable they are to other users, as well as specify characteristics they require in others as part of the matching process, for example, age, ethnicity, distance, or other physical, religious or location characteristics. For instance, certain religions may have different sects or sub-divisions (for example, Judaism includes Reform, Conservative and Orthodox groups (as well as sub-groups thereof), likewise “Protestantism” includes, for example, Adventists, Anglicans, Baptists, Congregationalists, Lutherans, Methodists, Pentecostals, Presbyterians and Reformed (as well as subgroups thereof)) that, although they have the same basic tenets of religious practice, they do not all agree on liturgy or follow the same specific practices, and may deem certain views, rituals or practices of the other(s) incompatible in some respects with their views. With specific variants of the applications described herein, those aspects can readily be accommodated.

Once the user has set her discovery preferences (Step 108), the user is given the ability to optionally specify certain personal information (Step 110), for example, one or more of: gender, height, weight, favorite activit(y/ies), any preferred date location type(s), any preferred first date activit(y/ies), etc. Finally, the user may optionally be given the opportunity to select a profile picture (Step 112) from among her pictures in the profile of her social networking application(s). Optionally, in some variants, the user may alternatively be given the option to upload a picture for her profile or, if the user is using a smart phone for registration, to take a picture of herself that can be used as her profile picture. In addition, with some variants, the user may be given the option to directly edit the profile picture, obviating the need for the user to do so in a separate program and then upload it if editing is desired.

At this point it should be noted that, the foregoing order is merely illustrative. With different implementations, Steps 106, 108, 110 and 112, could occur in any different or alternative order.

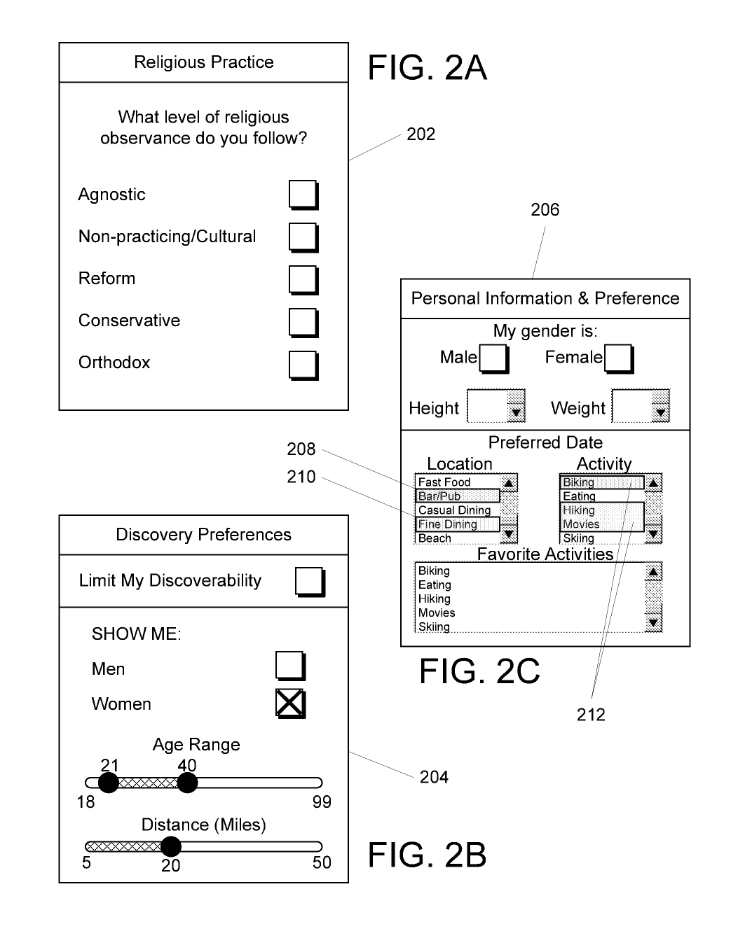

In connection with the foregoing process, FIGS. 2A-2C illustrate, in simplified form, representative examples of graphical user interfaces (GUIs) that can be presented to a user on, for purposes of this example, a smart phone.

Specifically, FIG. 2A illustrates, in simplified form, a representative example GUI 202 that might be presented to a user of a Jewish-specific variant in connection with Step 106 of FIG. 1. As shown in FIG. 2A, the GUI 202 that allows a Jewish user to specify their level of religious observance by simply selecting a “check box,” for example as shown, to specify that, the user is “Agnostic,” “Non-Practicing/Cultural,” “Reform,” “Conservative,” or “Orthodox.”

FIG. 2B illustrates, in simplified form, a representative example GUI 204 that might be presented to a user in connection with Step 108 of FIG. 1, to allow the user to specify, for example, that the user's discoverability should be limited, as well as details relating to limitations for other potential matches the user wishes to discover. For example, the user can specify if she wishes to discover men or women (or, in some cases, potentially both). Likewise, the user can specify an age range for any potential matches (e.g., as shown—ages 21 to 40). Similarly, the user can specify a distance range (e.g., as shown—between 5 and 20 miles). As to distance, depending upon the particular implementation, the distance can be based upon what the user may have specified during sign-up as her home address or, with some variants, it can be based upon obtaining the coordinates of the user from GPS, pseudo-GPS or other location means, provided by the user's mobile device. In this manner, it would be possible to discover someone who is transiently within the user's specified range.

FIG. 2C illustrates, in simplified form, a representative example GUI 206 that might be presented to a user in connection with Step 110 of FIG. 1. As shown, the GUI 206 allows the user to specify the user's gender and, optionally, height and/or weight (for example, by direct input or using appropriate menus or other input approaches provided in the GUI 206). Likewise, the user can optionally specify a preferred first date location (in this example case, “Bar/Pub” 208 and “Fine Dining” 210 have been selected as indicated by the grey background in FIG. 2C). In addition, the user can optionally specify preferred first date activit(y/ies), for example, as shown, “Biking,” “Hiking,” and “Movies” 212 have all been selected (as indicated in grey). Finally, a user may optionally be allowed to specify her own favorite activities. In this way, as will be discussed in more detail below, potential matches who like similar activit(y/ies) can thus be identified. In addition, with some implementations, users may be provided with the ability to provide an order of preference (i.e., ranking) such that, for example, the “Bar/Pub” choice could be preferred over “Fine Dining” or vice versa.

The information provided by the user, for example, the information of FIGS. 2A-2C, are used as search parameters for locating potential matches. The actual search is conducted by a matching engine that uses the user specified parameters to search for other users that meet one or more of those parameters. In addition, the matching engine can rank the identified potential matches based upon, for example, the amount of corresponding information, some form of weighting thereof, or any other appropriate method. Creation and implementation of a matching engine that can accomplish these types of searches is well known and well within the skill of those within the art, so the details thereof are not provided herein. Suffice it to say that any matching engine that can accomplish the matching tasks described herein could be used.

Depending upon the particular implementation, the search can be limited to matching based only on that information or, in other implementations, can use the search parameters to expand the search to social media of the users. For example, if a user has indicated a favorite activity is horseback riding, the search engine of the instant application can expand the search to include, for example, social media postings by potential matching users referencing horses, “tagging” of pictures with horseback riding related text, indications in a person's profile of “likes” for stables, riding academies, horse breeders, tack shops, etc.

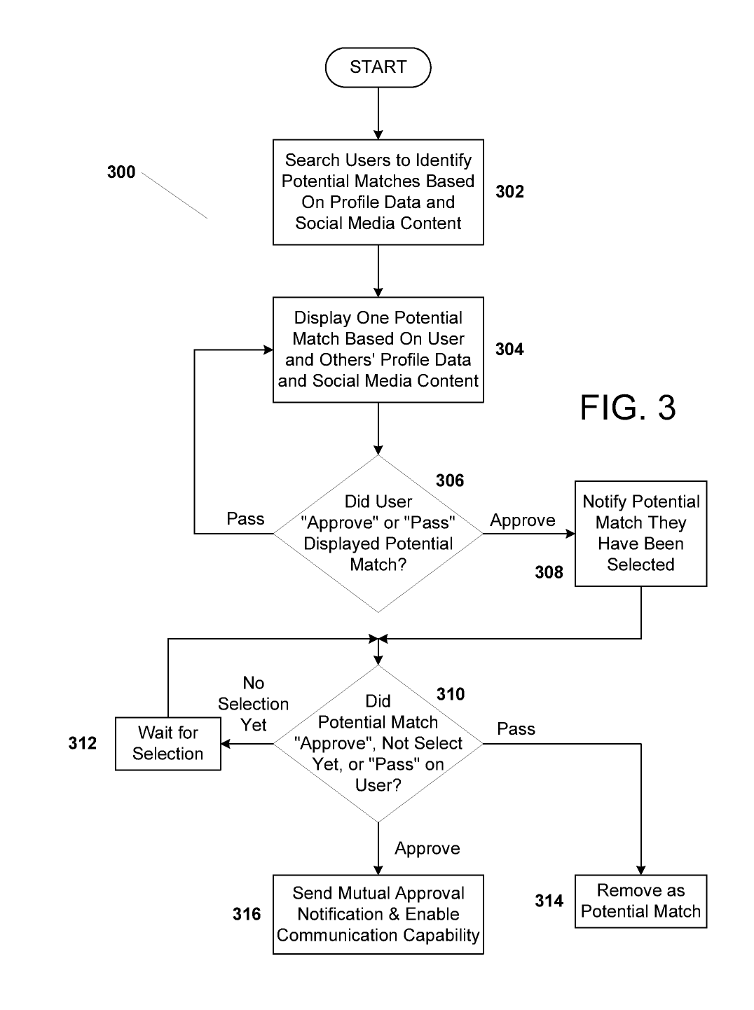

FIG. 3 illustrates, in simplified functional form, a flowchart 300 for an example implementation of the matching process.

The process begins with the user indicating that she would like to search for a match (Step 302). The matching engine then searches for matches. Since the display area of many mobile devices, like smart phones, smart watches or smart glasses, can be rather small, if one or more matches are found based upon the user's and other members' profile data (and optionally social media content), the application will display only the first match for the user in an appropriate GUI (Step 304). Of course, with other implementations, or if screen area allows it, more than one match can be displayed. However, in order to ensure review by the user, it is desirable (but not required) that a user either “Approve” (i.e., select) or “Pass” (i.e., reject) a potential match before another match is displayed (Step 306). If the user selects “Pass,” that displayed potential match is removed and the next potential match is displayed (Step 304), with the process repeating until all potential matches have been reviewed and either been approved or passed.

Either as each potential match is approved, after all potential matches have been approved, or after a user has selected someone and that someone has also mutually selected the user (without either knowing about the other's selection), depending upon the particular implementation, the potential match(es) are notified that they have been selected (Step 308). As part of the notification, each such potential match will be provided with a display providing the same or similar information for the user that selected them as the user would have seen for them. The notification recipient will then be given the opportunity to “Approve” or “Pass” on the user who triggered the notification. The application periodically checks whether the notification recipient has selected “Approve” or “Pass” and, if not, it will wait (Step 312) and then check again at a time thereafter, repeating the process until a selection has been made by the notification recipient.

Once the notification recipient has made a selection, if the selection is “Pass,” then the user who prompted the notification is removed as a potential match for the notification recipient and the notification recipient is removed as a potential match for the user (Step 314).

If, on the other hand, the notification recipient selects “Approve,” then an appropriate mutual approval notification is provided to the user and communication capability between the two is enabled (Step 316). Depending upon the particular implementation, this capability can range from providing an internal “chat” or short message system “SMS” (i.e., texting) capability to facilitating (or initiating) a call bridge connection between the two. In other words, the communication capability can be synchronous or asynchronous based upon the particular implementation. Likewise, if multiple potential matches have approved of the user, the user can optionally be provided with a list of those who approved so that the user can select the particular potential match with whom the user wants to communicate at a given time.

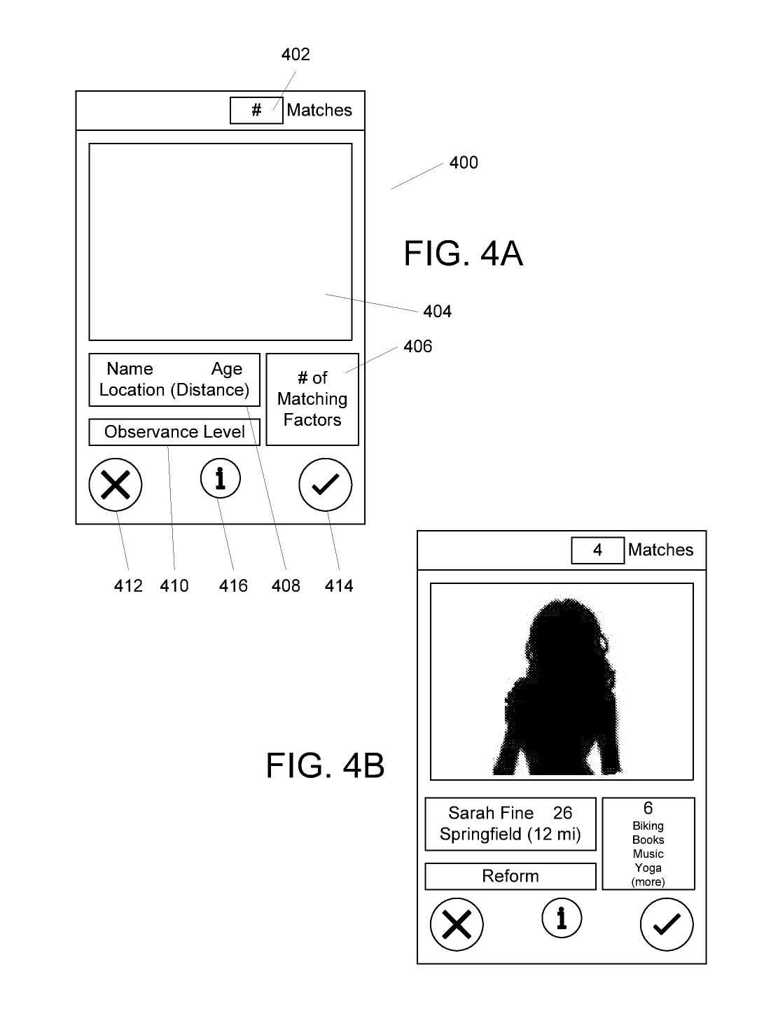

FIG. 4A illustrates, in simplified form, a representative example of a template for a GUI 400 that might be presented to a user in connection with Steps 304 and 306 of FIG. 3. As shown, the template 400 includes an area 402 where the total number of matches for the user can be displayed, an area 404 where the profile picture of the particular match being displayed can be presented, and an area 406 where the number of particular matching factors can be presented. Optionally, the area 406 can be configured such that the specifically matched factors (e.g., profile or other information) can be identified or it can be configured such that selection would be required in order for the user to see which factors matched. The template 400 likewise includes an area 408 within which the name, age and location (for example) of the displayed potential match can be presented. The template 400 also includes an area 410 where the religious observance level selected by the potential match can be displayed.

Finally, the template 400 includes selectable icons 412, 414 via which the user can indicate “Pass” (illustratively via an “X” icon 412) or “Approve” (illustratively via a “check” icon 414) and may optionally include a further “Information” icon 416 via which the user can obtain additional information about the potential match, for example, in some variants, by causing display of the potential match's full profile (or some subset thereof if discoverability is limited), and in other variants, by, for example, causing display of the potential match's linked social media page(s).

FIG. 4B illustrates in simplified form, the template 400 of FIG. 4A as it might be populated (using a fictitious example) following a search for matches for a user.

With continuing reference to FIGS. 4A-4B, it can be seen that this example search resulted in 4 matches (populated in the pertinent area 402). As indicated in the pertinent area 408, this particular match is a woman by the name of “Sarah Fine,” age 26 from Springfield, which is identified as 12 miles from the user and Ms. Fine's profile picture appears in the relevant area 404. In this implementation, there is an indication in the pertinent area 406 that “6” factors matched, only 4 of which are shown due to the size of the area, “Biking,” “Books,” “Music” and “Yoga.” With this GUI template 400, if the user wished to see the rest of the matching factors, the user could select the area 406 and the additional matched factors (or the full list) would be displayed to the user. Finally, Ms. Fine's level of observance “Reform” is noted in the appropriate area 410.

Of course, the template 400 could also be configured to include a display or indication of pertinent information gleaned from the social media information of the match, such as mutual “friend,” school, social organization(s) or other connections that they have in common.

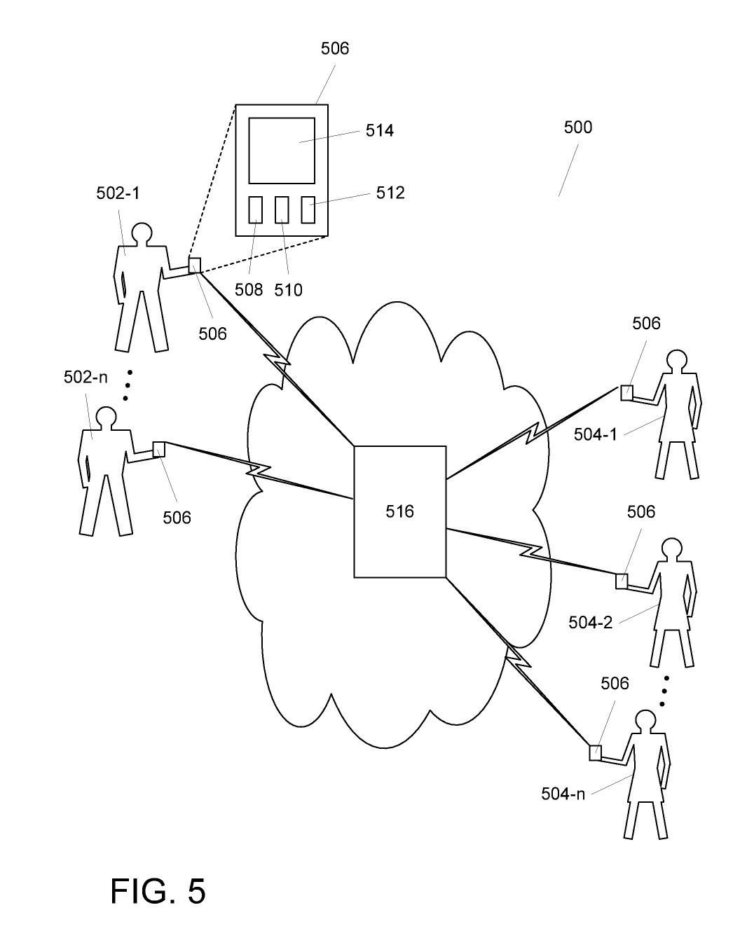

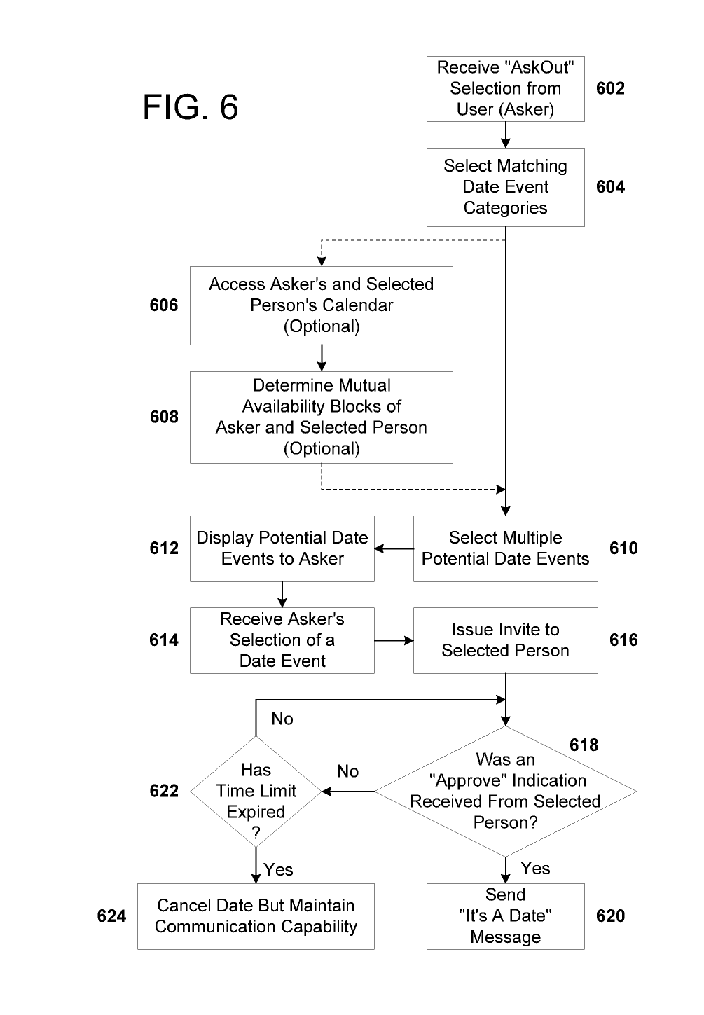

A further feature of the proximity-based matchmaking described herein is the “AskOut” feature. Once a user has matched someone and they have “Approved” of the user, one or more of the subsequently displayed screens involving that person will include a selectable “AskOut” indicator via which a date event can be automatically generated for them. This feature will now be discussed in connection with FIGS. 5-6.

FIG. 5 illustrates, in simplified form an example representation of a system 500 as described herein in its environment. The system environment involves multiple registered users 502-1, . . . , 502-n (male), 504-1, 504-2, . . . , 504-n (female), who each have a mobile device 506 on which an application according to one of the variants described herein is running. As referenced above, the mobile device includes at least a processor 508, non-transient storage 510 (which includes both application program and data storage), appropriate input/output (“I/O”) hardware 512 and a display 514 via which the user can interact with the GUIs described above. The proximity-based matchmaking application programs as described herein on each user's mobile device 506, interacts with the system 516 of the proximity-based matchmaking application program provider to accomplish the tasks described herein. In this regard, presume that a specific user 502-1 has been matched and “Approved” by two other users 504-1, 504-2. After some communication, the specific user 502-1 decides to use the “AskOut” feature to ask one of their “Approved” matches 504-2 for a date. The process for this feature will now be described in connection with FIG. 6.

FIG. 6 illustrates, in simplified form, a flowchart 600 for the “AskOut” process.

Specifically, in overview, by selecting the “AskOut” indicator, based upon the preference information provided by each, one or more (typically 3) specific proposed real world date events will be generated, in terms of “Category” of activity, location and date/time, as an automated process for selection.

Thus, turning to FIG. 6, when the user (“Asker”) selects the “AskOut” indicator the application program receives that selection (Step 602) and begins the process of generating one or more date events.

Depending upon the particular implementation, this may involve providing the user with a spread of options both in Category and time using a further automated matching protocol and, for example, both people's preferences (Step 604). The “AskOut” feature could automatically provide one or more date events to the user for selection (Step 610) as described below. This may entail providing details on available options in terms of dates and times, displaying a map of one or more suggested venue locations or locations within an area that could be selected as the date venue, or other details that might be useful or desirable for the user to have to assist in making a date selection.

Alternatively or additionally, this may optionally involve the system accessing the user's calendar and the calendar of the person the user seeks to initiate a date with (Step 606) via the “AskOut” feature to identify mutually free days and times during which a date might be scheduled (Step 608). Of course, this aspect is only as good at avoiding schedule conflicts as the accurateness of each person's calendar reflects, but it can avoid an awkward proposal of dates where the person being asked has no availability. Depending upon the particular implementation, this feature can be implemented via a calendar maintained on the user's mobile device within the system or external to the system (e.g., a third party calendar).

By way of example, according to one example simple matching protocol, if both have selected “Fine Dining” as a preferred date category, that would be the category of date event. Alternatively, with a ranking variant, a protocol could be used such that, for example, if both ranked a particular activity as highest priority, that would be chosen, but if the highest priority activities did not match, then a match of the second highest priority would control, if the second highest priority did not match, then the system could compare the “asked” person's highest three priority activities against the user's highest three priority activities and, if there was any commonality (irrespective of specific rank), that would be the activity chosen. Of course, these are just two representative examples; any appropriate protocol could be used. Once the particular category was determined, the “AskOut” feature would automatically select (Step 610) a suitable number (typically between 1 and 3) of specific mutually-accessible locations within that category based upon, for example, the relative locations of the two people and, in some implementations, taking into account within its selection protocol external information, for example, third-party ratings or reviews.

If the optional calendar-related feature was likewise implemented, the application on the user's mobile device would communicate in the background with the corresponding application on the other person's mobile device (with or without the other person's knowledge) to simply compare the two for mutually corresponding free blocks of time (i.e., without regard to the event or any personal information may be reflected therein). For privacy purposes, the application program could be set up to review the user's calendar and merely identify free blocks, for example, Wednesday between 8 pm and 9 pm, Thursday after 7 pm, Saturday after 7 pm and Sunday between noon and 4 pm and then after 8 pm. The system could be set up to treat free blocks that are less than a certain amount of time, for example, one hour as busy. The user's application could then query the other person's application to the effect: “Is there a free block Wednesday between 8 pm and 9 pm?” If it receives a positive acknowledgement, it will include that time block as a possibility for a date event and then issue the next query: “Is there a free block Thursday after 7 pm?” A potential response might be “Yes, there is a free block between 8:30 pm and 11 pm,” in which case a date starting at 8:30 pm (or thereafter to allow for travel) could be proposed. Once all the free blocks of time within a specified period, for example, the following week are ascertained, the system will generate date events within one or more of those free blocks of time. In this manner, the possibility of rejection due to a scheduling conflict is reduced.

That information would then be displayed to the “Asker” (Step 612) who could, depending upon the particular implementation, select (Step 614) a specific one of the automatically proposed activities and one or more of the automatically proposed date(s) and time(s), or could merely select or specify a particular data and time, in which case, the activity selection could be left to the person being Asked or, in some implementations, could be automatically selected if the person being Asked did not select one either. In other implementations, the user will be presented with a set of the automatically generated activity and date options and will have the option to either “accept” or “reject” them. If they are rejected, a new set will be automatically generated and the display refreshed to reflect the new set.

Once the automated selection is complete, the user can trigger an “invite” action. Once the “invite” action is triggered, the person being Asked will receive a notification (Step 616) indicating that they have been Asked Out (optionally also including a notification to the Asker that the invite was delivered and/or viewed), informing the person being Asked of the automatically provided or user specified date(s) and time(s) and giving him them the opportunity to (depending upon implementation variant) agree to the selection, select one or, in some variants, counter-propose an alternative date and time (Step 618). If the person being Asked approves of one of the choices, the user will be notified that “It's A Date” (Step 620). Depending upon the particular implementation, the date may be indicated in a calendar that is part of the application and optionally, reminders can be provided to each as the day/time approaches, and/or an event that can be imported into the respective people's external calendar can be generated and provided.

If, for some reason, none of the choices are acceptable to the person being Asked, he can simply ignore the “invite” and it will expire after a specified period of time (Step 622). It should be noted at this point that, although the Asker's selected date is cancelled by expiration, the communication capability continues to be available so that an awkward unintended rejection can be avoided (Step 624). Thus, if none of the options provided to the person being Asked were acceptable due to, for example, lack of availability for those days or times, they could simply contact the Asker and tell them of that fact and ask them to do a new “AskOut” or, in some implementations, the person being Asked could also invoke the “AskOut” feature to cause automated generation of a date event from the other person's side.

In addition, if a particular option is acceptable, with some implementations the application will be configured to automatically book reservations for the date, for example, via an application like OpenTable, Reservation Genie, or other on-line ticket reservation systems. In that regard, for implementations that can book activities in which a reservation may require a deposit, the application can require the “Asker” to input some form of payment information, for example, credit card or PayPal account information.

It should be understood that this description (including the figures) only includes some illustrative embodiments. For the convenience of the reader, the illustrative embodiments of the above description is a representative sample of all possible embodiments, a sample that teaches the principles of the invention. The description has not attempted to exhaustively enumerate all possible variations. That alternate embodiments may not have been presented for a specific portion of any variant, or that further non-described alternate embodiments may be available for a portion of a variant, is not to be considered a disclaimer (intentional or unintentional) of those alternate embodiments. One of ordinary skill will appreciate that many of those non-described embodiments incorporate the same principles of the claimed invention and that others are equivalent thereto.

1. A mobile device proximity-based matchmaking system, comprising:
a mobile device including
a processor, and
non-transient application software running on the processor of the mobile device, the application software being configured to, when executed, implement a matching engine, the application software being further configured to, when executed, cause the processor of the mobile device to
i) use information, supplied by a user of the proximity-based matchmaking system, in the matching engine to identify multiple potential matches for the user within a user-set range, as determined using a GPS technique, by comparing at least some of the information supplied by the user to information supplied by other registered users of the proximity-based matchmaking system;
ii) identify to the user, in a graphical user interface (GUI) of the user's mobile device, potential matches from among the other registered users based upon at least the information supplied by other registered users;
iii) receive an indication from the user via the GUI that the user has selected at least one of the potential matches;
iv) send a notification to the at least one of the potential matches indicating the selection;
v) receive from the at least one of the potential matches an approval of the user such that the at least one potential match will be a matched user;
vi) receive an “AskOut” selection from the user via the GUI with respect to the matched user;
vii) automatically generate in response to the received “AskOut” selection and specific to the user and the matched user, based upon at least supplied information from the user and private information supplied by the matched user, at least one date event that is within a specified distance for both the user and the matched user, and present the at least one date event to the user via the GUI;
viii) receive date-related input from the user via the GUI;
ix) transmit at least one particular date event to the matched user;
x) receive an indication from the matched user of their acceptance of a specific date event selected from among the at least one particular date event; and
xi) automatically book a reservation for the specific date event.

2. The mobile device proximity-based matchmaking system of claim 1, wherein the GUI of “ii)” includes at least two of the following areas:
a total number of matches area,
a profile picture display area,
a religious observance level indication area, and
an area where the user can “Approve” or “Pass” with respect to an individual potential match.

3. The mobile device proximity-based matchmaking system of claim 2, wherein the GUI of “ii)” further includes an area for display of any one or more of:
a potential match name, a potential match age, a potential match location or a potential match's distance from the user.

4. The mobile device proximity-based matchmaking system of claim 1, wherein the potential matches identified in “i)” are identified by the matching engine by comparing other members registered with the mobile device proximity-based matchmaking system on the basis of any one or more of: religion, religious observance level, age, ethnicity, distance, location-related characteristics, and social media information.

5. The mobile device proximity-based matchmaking system of claim 1, wherein the information supplied by the user of the proximity-based matchmaking system includes multiple selectable first date preference category choices displayable to a user via the GUI.

6. The mobile device proximity-based matchmaking system of claim 1, wherein the information supplied by the user of the proximity-based matchmaking system includes multiple selectable first date preference activity choices displayable to a user via the GUI.

7. The mobile device proximity-based matchmaking system of claim 1, wherein the non-transient application software running on the processor of the mobile device is configured to, in between “v)” and “vi)”:
enable communication capability between the user and the matched user.

8. The mobile device proximity-based matchmaking system of claim 1, wherein the non-transient application software running on the processor of the mobile device is configured to perform “ii)” by displaying a first potential match to the user and, in response, receive a selection input by the user of either an “Approve” or “Pass” selection.

9. The mobile device proximity-based matchmaking system of claim 1, wherein the non-transient application software running on the processor of the mobile device is configured to, in between “v)” and “vii”:
determine mutually free blocks of time for the user and matched user, wherein the at least one date event is automatically generated in “vii” within one of the determined mutually free blocks of time.

10. The mobile device proximity-based matchmaking system of claim 9, wherein the system is configured to determine the mutually free blocks of time for the user and matched user by:
accessing a calendar of the user and identifying the free blocks of time for the user;
accessing a calendar of the matched user, that is maintained as private from the user, and identifying the free blocks of time for the matched user; and
determining whether any of the free blocks of time for the user and free blocks of time for the matched user correspond.

11. The mobile device proximity-based matchmaking system of claim 1, wherein the private information supplied from the matched user includes the matched user's location.
